(19) United States
(12) Patent Application Publication
(10) Pub. No.: US 2026/0327876 A1
(43) Pub. Date: Oct. 22, 2026

(54) TEXTILE ARRANGEMENT FOR HIGH-PERFORMANCE PASSIVE GREEN ROOF IRRIGATION

(71) Applicant: ZinCo GmbH, Nürtingen (DE)

(72) Inventor: Ralf Walker, Metzingen (DE)

(73) Assignee: ZinCo GmbH, Nürtingen (DE)

(21) Appl. No.: 19/650,068

(22) Filed: Apr. 16, 2026

(30) Foreign Application Priority Data
Apr. 17, 2025 (DE) 102025115257.8

(51) Int. Cl. D04H 3/016; D04H 3/011; D04H 3/018; D04H 3/11

(52) U.S. Cl. CPC D04H 3/016; D04H 3/011; D04H 3/018; D04H 3/11; D10B 2505/204

(57) ABSTRACT

A textile arrangement for irrigating a flat roof planting has a first textile on a first spacer block. The first textile extends downwards at least on one end face of the first spacer block in order to be able to draw up accumulated water on a flat roof by capillary force. The first textile is particularly absorbent because it has cross-linked microfilaments which in cross-section have the shape of a pizza with multiple pizza slices, or are star-shaped in cross-section. The microfilaments can be at least partially welded together. Preferably, a substrate for growing a plant is piled up directly on the first textile. In a further preferred embodiment, multiple spacer blocks are each provided with a textile described herein, preferably the same textile, and are connected to each other to form a large-area, in particular, gap-free, assembly.

### CROSS-REFERENCE TO RELATED APPLICATIONS

This application claims priority to German Patent Application No. DE 10 2025 115 257.8, filed Apr. 17, 2025, the entire contents of which are hereby incorporated in full by this reference.

### DESCRIPTION

### FIELD OF THE INVENTION

The invention relates to a textile arrangement for a flat roof planting. The invention further relates to a flat roof having such a textile arrangement, as well as to a method for producing such a textile arrangement, and to the use of such a textile arrangement for growing a plant.

### BACKGROUND OF THE INVENTION

Due to climate change and the associated long periods of drought, green roofs must be able to supply water to the plants planted there even when it does not rain for extended periods. Furthermore, due to climate change, green roofs will need to be able to store large amounts of water and allow it to evaporate through the vegetation in order to cool cities during heat waves.

One way to water plants is to actively supply them with water using a pump. However, energy must be used to operate the pump. Furthermore, a pump with many moving parts is prone to malfunctions and requires repairs.

Therefore, retention systems were developed in which plants are arranged on a raised platform above a water reservoir, with textiles suspended in the water reservoir whose capillary forces passively draw the water upwards towards the plants. However, a disadvantage of these retention systems is that the rate at which the water is extracted is insufficient to irrigate intensive plantings, let alone to provide the necessary evaporation rates for urban cooling. While it is generally possible to use fiberglass or similar materials, this leads to undesirable waste mixtures when disposing of such a retention system. Natural fibers, on the other hand, rot and have a short lifespan.

Various textiles have been tested over more than 15 years, but so far none have been found that meet the requirements for capillary force.

### SUMMARY OF THE INVENTION

Object of the invention: The object of the invention is therefore to provide a high irrigation rate for a green roof in a passive manner.

Description of the invention: This object is achieved according to the invention by a textile arrangement according to claim 1, a flat roof according to claim 10, a method according to claim 11, and a method according to claim 12. The dependent claims reflect preferred developments.

The object according to the invention is thus achieved by a textile arrangement for a flat roof planting, having the following features:
a) a first spacer block;
b) a first textile extending on the top surface of the first spacer block and downwards on a first end face of the first spacer block, wherein the first textile has cross-linked microfilaments that are at least partially composed of polyester.

The textile arrangement according to the invention allows a high water replenishment rate of up to 2.5 L/m² per day, for large height differences of, for example, 20 cm, which was not possible with previously known capillary structures at this height. With a height difference of 15 cm, even replenishment rates of up to 4.5 L/m² per day are achieved.

A spacer block is understood to be a preferably cuboid, solid body which preferably has a plurality of passage openings to allow water that accumulates on a flat roof to permeate it. A spacer block can be made in a single piece, in multiple pieces, and/or of plastic. A spacer block is preferably designed to distance a textile arranged on it from a base on which the spacer block rests. Therefore, water can be stored under the textile using the spacer block. Multiple coupled spacer blocks enable the desired retention volume.

The top surface of the first spacer block can be polygonal, in particular, rectangular, preferably square. The length and width of the rectangular top surface are preferably between 0.2 m and 2 m, in particular, between 0.4 m and 1.0 m. The vertical thickness of the first spacer block is preferably between 0.05 m and 0.4 m, in particular, between 0.08 m and 0.25 m.

A textile is understood to be a flexible textile structure, especially one in contact with the earth, and particularly in the form of a geotextile. The textile can be rot-proof. The textile should preferably be water-permeable. The textile can be designed in the form of a non-woven. The textile is preferably designed to conduct water to a substrate arranged on the textile for the purpose of irrigating a plant.

The terms “above,” “below,” “on,” etc., used here refer to the installed state of the textile arrangement on a flat roof. “On” means “above,” preferably “directly on.”

The polyester can be in the form of polyethylene terephthalate (PET).

The first textile can be composed of more than 70%, and, in particular, more than 90%, polyester.

The microfilaments can be interconnected without solvents or binders. This makes the first textile easier to recycle.

The first textile can consist of microfilaments, making it particularly absorbent.

The first textile preferably extends downwards along multiple end faces of the first spacer block in order to reach into the water. The first textile particularly preferably extends downwards along all end faces of the first spacer block.

The end faces preferably extend between the larger top surface and the larger bottom surface of the first spacer block. The first textile preferably extends downwards on the end face(s) all the way to the bottom surface.

The first textile can be cut to size, particularly in the shape of the spacer block, with a flap on each side. This allows the first textile to be easily arranged on the first spacer block.

In a particularly preferred embodiment of the invention, the microfilaments are star-shaped or pizza-shaped in cross-section (circular overall, with triangular individual pieces). In these cases, the first textile exhibits particularly strong capillary forces.

If the microfilaments are made of two components, they can be spliced to create particularly large volumes.

Particularly preferably, the first textile can have polyester and polyamide (PA), especially in the form of polyamide 6, and can preferably consist of polyester and PA.

The microfilaments preferably have a thickness between 100 nm and 500 nm. In a further preferred embodiment of the invention, the microfilaments have a fineness between 0.01 dtex and 1 dtex.

The first textile can have a passage opening, wherein the textile arrangement has a fastening means, e.g., a pin, which is passed through a passage opening of the first textile and fixed to the first spacer block. This allows a unit consisting of the first spacer block and the first textile to be easily laid on the flat roof.

The passage opening can be in the form of a borehole or at least a slot - for example, a cross-slot.

The passage opening can be formed in the middle of the first textile to effectively prevent the first textile from slipping on the first spacer block.

Furthermore, the first textile is preferably designed to be drill-resistant, so that it can be easily worked with machine tools without getting stuck on the tool.

To further increase the absorbency or capillarity of the textile arrangement, the first textile can be provided on one or both sides with a film spaced apart from the microfilaments by a narrow gap. The film can have polyester, and, in particular, can be made of polyester.

The textile arrangement can have a substrate, above the first textile, for growing a plant. A mixture of pumice, lava, and compost, for example, can be used as a substrate. The substrate is preferably blowable.

In a particularly preferred embodiment of the invention, the substrate is arranged directly on the first textile. By eliminating the need for a flexible textile structure (“filter fleece”) between the first textile and the substrate, the substrate can be irrigated from below in a particularly efficient manner with a simple overall structure. In this case, the first textile takes on the function of the filter layer to prevent fine particles from being washed out of the substrate.

The textile arrangement can have a second spacer block connected to the first spacer block. A second textile can be arranged on the top surface of the second spacer block, extending downwards along a first end face of the second spacer block. Therefore, the first textile and the second textile can be arranged, in particular, clamped, between the end faces of the first spacer block and the second spacer block. The second textile can contain cross-linked microfilaments that consist at least partially of polyester.

The second spacer block is preferably directly connected to the first spacer block.

The first textile can have a spacer passage opening and the second textile can have a further spacer passage opening to easily connect the first spacer block to the second spacer block.

The second textile is preferably identical to the first textile. Preferably, the textile arrangement has a plurality of textiles - in particular, more than three textiles - which are preferably identical to the first textile.

The second spacer block is preferably identical to the first spacer block. The textile arrangement can have a plurality of spacer blocks - particularly more than three spacer blocks. The spacer blocks are preferably designed identically to the first spacer block.

The textile arrangement can have a block connecting means with a bow-tie shape, made of two opposing dovetails, connecting the first spacer block to the second spacer block.

The first spacer block and the second spacer block can each have a cutout that tapers towards the edge of the spacer block, and the block connecting means can be inserted into this cutout. The block connecting means, the first spacer block and the second spacer block are preferably designed such that the two spacer blocks are clamped against each other when the block connecting means is inserted into the cutouts. This prevents substrate from trickling into a gap between the spacer blocks.

Preferably, the first spacer block has a plurality of tubes connected to each other by webs. Alternatively or additionally, the first spacer block can be made of plastic and/or be a single piece. This allows the first spacer block to be manufactured in a stable and cost-effective manner.

The object according to the invention is further achieved by a flat roof having a textile arrangement as described herein.

It is particularly advantageous for a flat roof surface to be completely or almost completely covered with connected spacer blocks. This effectively prevents the spacer block assembly from slipping.

Furthermore, the object according to the invention is achieved by a method for producing a textile arrangement described herein, having the following method steps:
A) spinning continuous filaments having polyester;
B) laying the continuous filaments on a web;
C) splitting and solidifying the continuous filaments with high-pressure water jets to form the cross-linked microfilaments;
D) arranging the first textile with the cross-linked microfilaments on the first spacer block.

The term "high pressure" refers, in particular, to pressures between 50 bar and 500 bar, preferably between 100 bar and 400 bar, and most preferably between 200 bar and 350 bar.

After method step D), the method can further have the following method step:

H) applying, in particular, by blowing, the substrate to the first textile.

Before, after or between method steps A) to H), a further method step or further method steps can be carried out.

Preferably, polyester made from recycled PE bottles is used.

The object addressed according to the invention is finally achieved by the use of a textile arrangement described here as a base for a substrate for growing a plant, in particular, on a flat roof.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

FIG. 1 schematically shows a side view of a flat roof having a textile arrangement, wherein the textile arrangement has two spacer blocks connected to each other, on each of which a textile is arranged as a substrate carrier for a green roof.

FIG. 2a is a perspectival view of a first textile cut to size.

FIG. 2b is a plan view of the textile of FIG. 2a.

FIG. 3 is a top view of a textile arrangement, wherein a first spacer block is covered with a first textile and a second spacer block is not covered with a textile, in order to better illustrate the connection of the two spacer blocks.

FIG. 4 is a perspectival view of a textile arrangement having a first spacer block, a first textile arranged on it, and a holder.

FIG. 5 is a scanning electron microscopy image of a first textile at 50x magnification, in which microfilaments of the first textile can be seen.

FIG. 6 is a further enlarged perspectival view of some of the microfilaments of FIG. 5.

FIG. 7 shows method steps for manufacturing a textile arrangement.

### DETAILED DESCRIPTION OF THE PREFERRED EMBODIMENTS

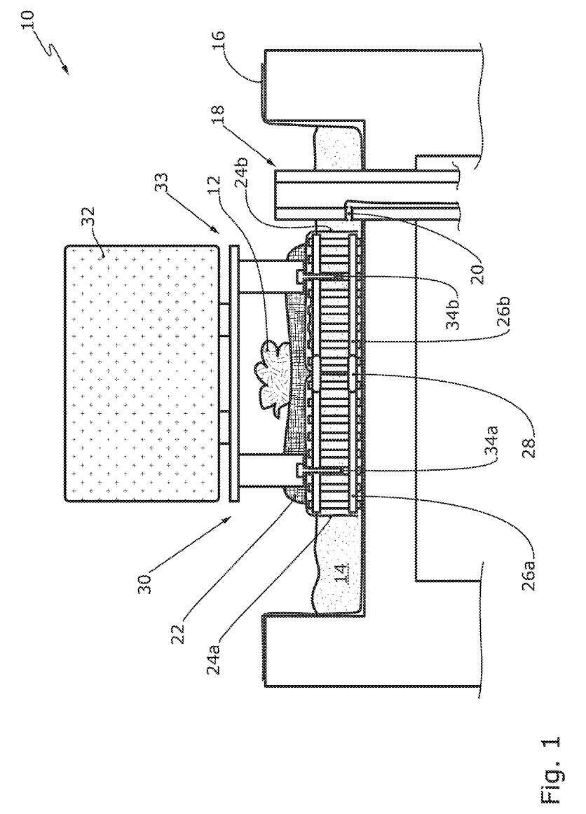

FIG. 1 shows a flat roof 10 planted with a plant 12. In order to irrigate the plant 12 as continuously as possible, water 14 is stored on the flat roof 10. For this purpose, a seal 16 is installed on the flat roof 10 - made particularly of bitumen or plastic. A drain 18 with a collection device is arranged in an elevated position to dam the water 14. Preferably, a throttle 20 is installed on the drain 18, in particular, in the form of a controllable throttle, provided to enable a controlled outflow of the water 14 for managing heavy rain.

The plant 12 is rooted in a substrate 22. The substrate 22 is arranged on a first textile 24a and a second textile 24b. Preferably, the substrate 22 is arranged directly (without any further intermediate layer) on the first textile 24a and the second textile 24b. This simplifies the overall design and installation.

The first textile 24a lies on the top surface of a first spacer block 26a; the second textile 24b lies on the top surface of a second spacer block 26b. The spacer blocks 26a, b are designed to be water-permeable.

The spacer blocks 26a, b are connected by multiple block connecting means, a first of which is designated by the reference symbol 28. The block connecting means 28 clamp the spacer blocks 26a, b to each other, so that no substrate 22 falls into a gap between the first textile 24a and the second textile 24b.

The first textile 24a and the second textile 24b are preferably identical in design. The spacer blocks 26a and 26b are also preferably identical in design.

The first textile 24a and the second textile 24b are preferably designed to be absorbent in order to transport the water 14 to the substrate 22, where it can be absorbed by the plant 12. A textile arrangement 30 comprised of the spacer blocks 26a, b and the textiles 24a, 24b thus enables irrigation of the plant 12 over a long period of time.

In the present case, the textile arrangement 30 further serves to hold an object 32. The object 32 can be in the form of a building technology device - for example, a heat pump component or an air conditioning component. Alternatively, the object can be designed in the form of a fall protection device or – as shown in FIG. 1 – a photovoltaic module.

The object 32 is mounted via a holder 33 on the spacer blocks 26a, b, wherein the holder 33 is fastened via a first holder connecting means 34a to the first spacer block 26a and via a second holder connecting means 34b to the second spacer block 26b. The holder connecting means 34a, b can each be in the form of a screw, in particular, in the form of a self-tapping screw. The holder connecting means 34a, b particularly preferably do not engage around the spacer blocks 26a, b (as shown in FIG. 1), such that they are particularly easy to install.

The substrate 22 is particularly preferably blown on when the holder connecting means 34a, b are installed, but the object 32 and the holder 33 are not yet installed. Therefore, the installation steps can be decoupled according to the invention, by virtue of the holder connecting means 34a, b being initially installed by themselves. In this case, substrate 22 can be applied particularly easily, especially by blowing it on. Then the holder 33 and the object 33 can be installed.

Due to the (indirect) connection of the object 32 to the spacer blocks 26a, b, the object 32 no longer necessarily needs to be attached to another part of the building. In particular, the film 16 does not need to be pierced in order to attach the object 32.

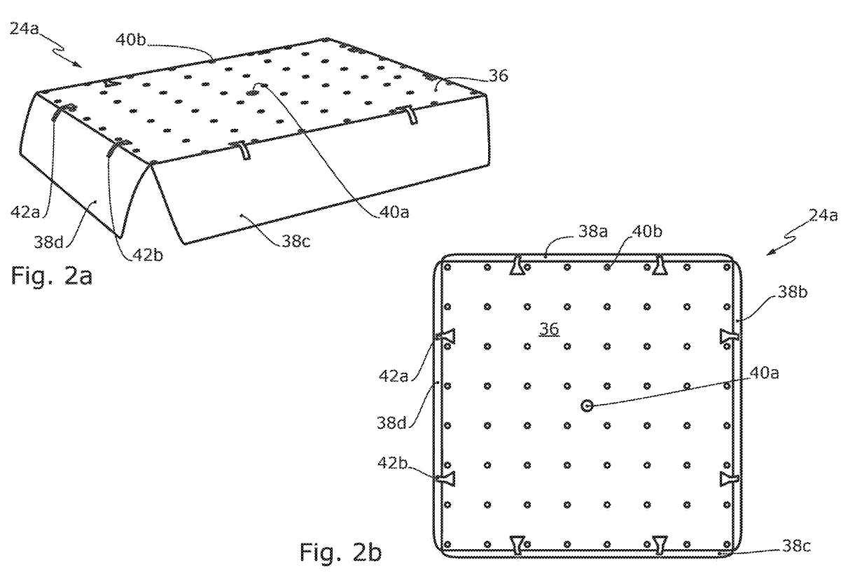

FIGS. 2a, 2b show an embodiment of a first textile 24a. The first textile 24a preferably has a rectangular shape, in particular – as shown in FIGS. 2a,b – a square top surface 36. The top surface 36 is connected to side flaps 38a, 38b, 38c, 38d, in particular, in one piece. In the installed state of the textile arrangement 30 (see FIG. 1), the side flaps 38a-d protrude downwards to be able to absorb accumulated water (see FIG. 1 at reference signs 24a, b).

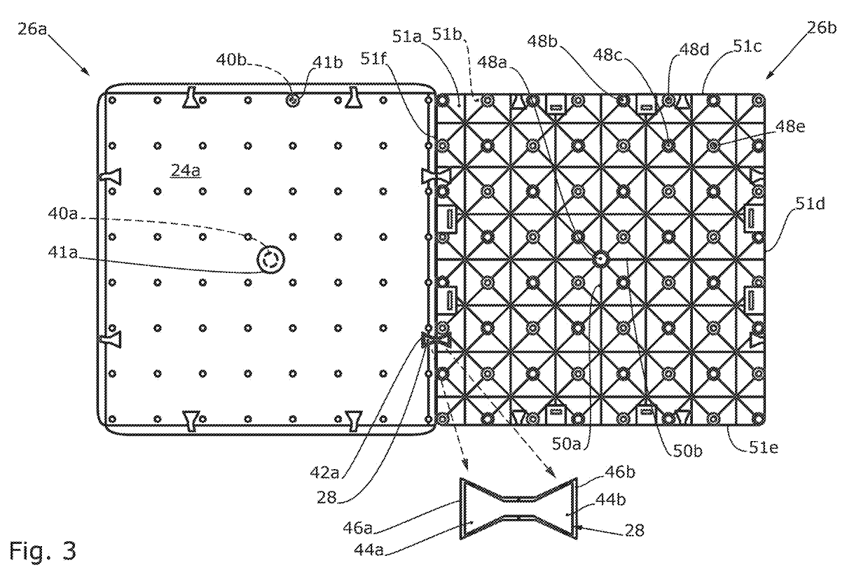

The first textile 24a has multiple passage openings and/or markings, of which in FIGS. 2a, b two are designated by reference signs 40a, 40b. A fastening means, e.g., a pin or a screw, can be guided through each of the passage openings and/or markings 40a, b, to fix the first textile 24a to the first spacer block 26a (see FIG. 3). FIG. 3 shows two fastening means 41a, 41b, which are guided into the passage openings or markings 40a, b. If the first textile 24a is fixed to the first spacer block 26a, such a textile arrangement 30 (see FIG. 1a) can be made particularly compact and easy to install.

The passage opening(s) or marking(s) 40a, b can be in the form of embossings, slots or boreholes, or alternatively in the form of lettering. Preferably, the first textile 24a has a central passage opening (here, 40a) in the center of the top surface 36 (see FIG. 2b). This allows the first textile 24a to be held in a particularly positionally-accurate manner on the first spacer block 26a.

The first textile 24a furthermore has multiple spacer passage openings, of which two are designated by the reference signs 42a, 42b in FIGS. 2a, b. The spacer passage openings 42a, b serve to facilitate the connection of two adjacent spacer blocks 26a, b (see FIG. 1). This will be explained in more detail below in connection with FIG. 3.

FIG. 3 shows a first spacer block 26a and a second spacer block 26b. A first textile 24a is arranged on the first spacer block 26a. A second textile, which is actually arranged on the second spacer block 26b, is hidden in FIG. 3 in order to improve the explanation of the connection between the spacer blocks 26a, b.

The two spacer blocks 26a, b are connected via multiple block connecting means, of which one block connecting means 28 is shown in FIG. 3. The block connecting means 28 is shaped like a bow tie or like the letter I. It has opposing, connected dovetails 44a, 44b. The block connecting means 28 is preferably formed in one piece.

The block connecting means 28 locks into cutouts 46a, 46b of the spacer blocks 26a, b which taper towards the edge of the spacer blocks 26a, b. The block connecting means 28 passes through the spacer passage opening 42a of the first textile 24a.

FIG. 3 shows that the second spacer block 26b (like the first spacer block 26a) has a plurality of tubes running vertically, of which five tubes 48a, 48b, 48c, 48d, 48e are marked with a reference sign in FIG. 3. The central tube 48a is aligned with the passage opening 40a (see FIG. 2a); the tube 48b is aligned with the passage opening or marking 40b (see FIG. 2a). Preferably, multiple tubes 48a-e are each aligned with a passage opening or marking 40a, b, in particular, most tubes 48a-e, particularly preferably all tubes 48a-e.

The tubes 48a-e can have the same diameter or different diameters. In the present case, the tubes 48b and 48c have the same diameter, and the tubes 48d and 48e also have the same diameter. The second spacer block 26b has a grid pattern of tubes of a first diameter (here, for example, with tubes 48b, c). Furthermore, the second spacer block 26b has an offset grid pattern of tubes of a second diameter (here, for example, with tubes 48d, e). The tubes 48a-e are connected by webs, of which the webs 50a, 50b are designated with reference signs in FIG. 3.

The tubes 48a-e preferably have their openings on the top surface 51a and/or the bottom surface 51b of the second spacer block 26b. Between the top surface 51a and the bottom surface 51b, which constitute the large main faces of the second spacer block 26b, run the end faces 51c, 51d, 51e, 51f of the second spacer block 26b. The end faces 51c-f preferably extend perpendicularly to the longitudinal direction of the webs 50a, b and parallel to the longitudinal direction of the tubes 48a-e.

The second spacer block 26b can be made in one piece, particularly from plastic.

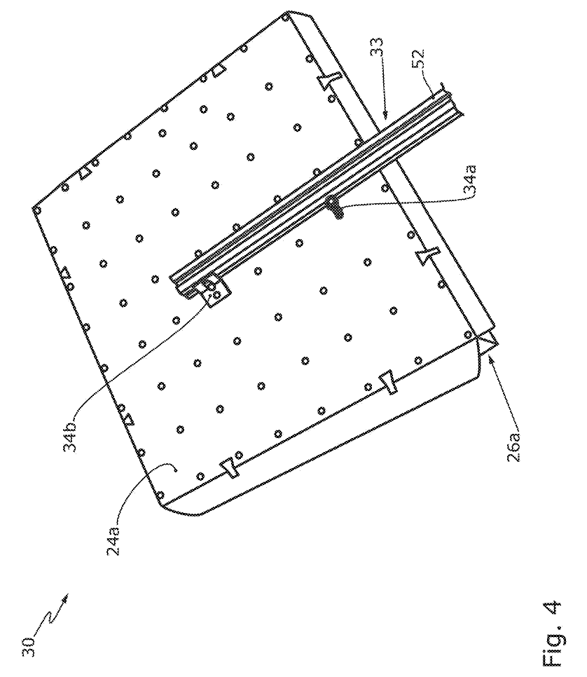

FIG. 4 shows a textile arrangement 30 having a first spacer block 26a on which a first textile 24a is arranged. A holder 33 has a rail 52 which extends over multiple spacer blocks (in FIG. 4, only a first spacer block 26a is shown). The holder 33 is attached to the first spacer block 26a via multiple holder connecting means 34a (here in the form of a screw), 34b (here in the form of a mounting bracket). The rail 52 leads to a stiffening of multiple spacer blocks (not shown in FIG. 4), making it more difficult to lift or lever them up. An object 32 (see FIG. 1) is thus more securely fastened. The rail 52 can be designed in the form of a profile rail with a cross-section of the same length along its longitudinal axis.

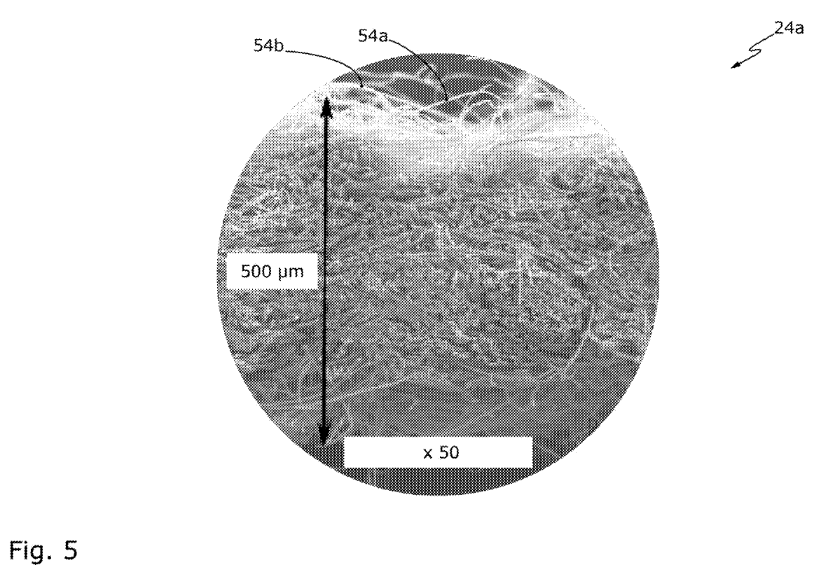

FIG. 5 shows a greatly enlarged image of a first textile 24a. FIG. 5 shows that the first textile 24a has a plurality of microfilaments, of which only two microfilaments 54a, 54b are as examples provided with reference signs in FIG. 5. Preferably, the first textile 24a – as in the present case – consists exclusively of microfilaments 54a, b.

The first textile 24a can have a thickness between 0.1 mm and 3 mm, in particular, between 0.2 mm and 2 mm, preferably (as shown) between 0.4 mm and 1 mm.

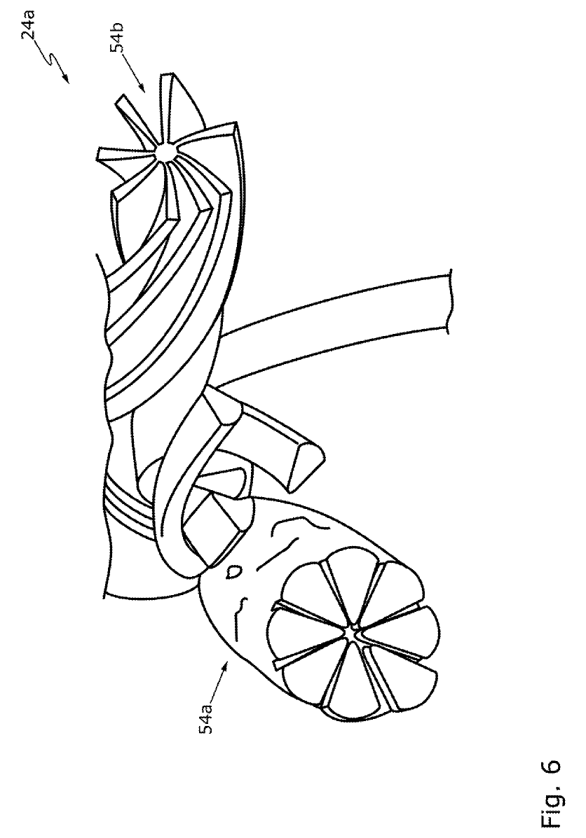

FIG. 6 shows a further enlarged image of the first textile 24a. According to FIG. 6, the microfilament 54a has a cross-section in the shape of a pizza with multiple pizza slices, and the microfilament 54b has a star-shaped cross-section. The microfilaments 54a, b are preferably made of PET, in particular, predominantly of PET, and PA. The first textile 24a generates exceptionally high capillary forces in water and enables water flow rates of more than 4 L/m² daily.

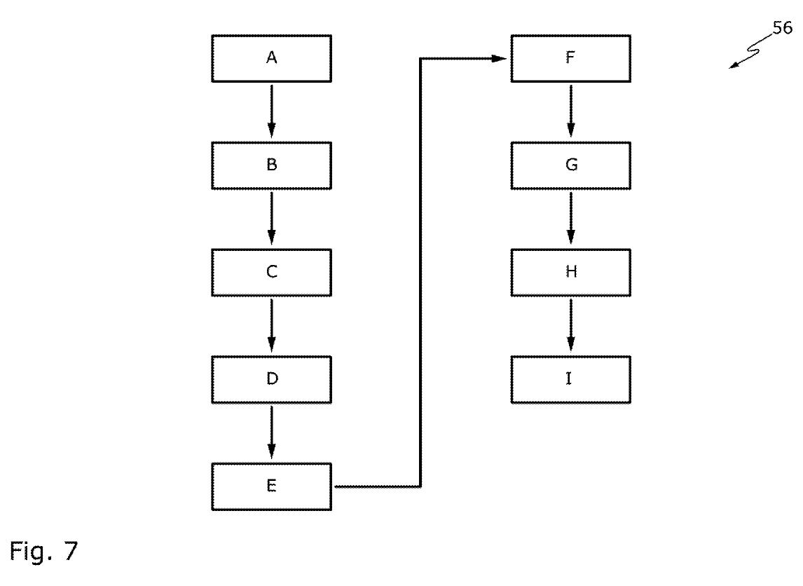

FIG. 7 shows a method 56 for producing a textile arrangement 30 according to the drawings, having the method steps of:
A) spinning continuous filaments;
B) laying the continuous filaments on a web;
C) splitting and solidifying the continuous filaments with high-pressure water jets to form the cross-linked microfilaments 54a, b in the form of a textile;
D) cutting the textile into a first textile 24a and a second textile 24b;
E) arranging the first textile 24a on a first spacer block 26a and arranging the second textile 24b on a second spacer block 26b;
F) connecting the spacer blocks 26a, b with a block connecting means 28;
G) fastening a holder 33 to the first spacer block 26a by means of a first holder connecting means 34a;
H) applying the substrate 22 to the first textile 24a and the second textile 24b;
I) fastening an object 32 to the holder 33.

Applying, in particular, by blowing, the substrate 22 before installing the object 32 significantly simplifies the processes for the flat roof planting 10. This is because, without the object 32, the substrate 22 can be applied easily and quickly over a wide area, especially through a hose (not shown).

Taking an overview of all the figures of the drawing, the invention relates in summary to a textile arrangement 30 for irrigating a flat roof planting. The textile arrangement 30 has a first textile 24a on a first spacer block 26a, wherein the first textile 24a extends downwards at least on one end face 51c of the first spacer block 26a, preferably on multiple end faces 51c-f, in particular, on all end faces 51c-f, in order to be able to draw up accumulated water on a flat roof 10 by capillary force. The first textile 24a is particularly absorbent because it has cross-linked microfilaments 54a, b which in cross-section have the shape of a pizza with multiple pizza slices, or are star-shaped in cross-section. The microfilaments 54a, b can be at least partially welded together. Preferably, a substrate 22 for growing a plant 12 is piled up directly on the first textile 24a. In a further preferred embodiment of the invention, multiple spacer blocks 26a, b are each provided with a textile 24a, b described herein, preferably of the same type, and are connected to each other to form a large-area, in particular, gap-free, assembly.

### LIST OF REFERENCE SIGNS

10 flat roof

12 plant

14 water

16 film

18 drain with accumulation device

20 throttle

22 substrate

24a first textile

24b second textile

26a first spacer block

26b second spacer block

28 block connecting means

30 textile arrangement

32 object

33 holder

34a first holder connecting means

34b second holder connecting means

36 top surface

38a-d side flap

40a, b passage opening or marking

41a, b fastening means

42a, b spacer passage opening

44a, b dovetail

46a, b cutout

48a-e tubes

50a, b webs

51a top surface

51b bottom surface

51c-f end faces

52 rail

54a, b microfilament

56 method

What is claimed is:

1. A textile arrangement configured for a flat roof planting, having the following:
a) a first spacer block;
b) a first textile extending on the top surface of the first spacer block and further extending downwards on a first end face of the first spacer block;
wherein the first textile has cross-linked microfilaments which consist at least partially of polyester.

2. The textile arrangement according to claim 1, wherein the first textile extends downwards on multiple end faces of the first spacer block.

3. The textile arrangement according to claim 1, wherein the microfilaments are pizza-shaped or star-shaped in cross-section.

4. The textile arrangement according to claim 1, wherein the microfilaments are bi-component.

5. The textile arrangement according to claim 1, wherein the textile arrangement has a fastening means which is guided through a passage opening of the first textile and fixed to the first spacer block to fasten the first textile to the first spacer block.

6. The textile arrangement according to claim 1, wherein the first textile is provided on one or both sides with a film spaced apart from the microfilaments.

7. The textile arrangement according to claim 1, wherein the textile arrangement has a substrate, above the first textile, for growing a plant.

8. The textile arrangement according to claim 7, wherein the substrate is arranged directly on the first textile.

9. The textile arrangement according to claim 1, wherein the textile arrangement has a second spacer block connected to the first spacer block, wherein a second textile is arranged on the top surface of the second spacer block and extends downwards on a first end face of the second spacer block, wherein the second textile has cross-linked microfilaments which consist at least partially of polyester.

10. A flat roof having the textile arrangement according to claim 1.

11. A method for producing the textile arrangement according to claim 1, having the method steps of:
A) spinning continuous filaments having polyester;
B) laying the continuous filaments on a web;
C) splitting and solidifying the continuous filaments with high-pressure water jets to form the cross-linked microfilaments (54a, b);
D) arranging the first textile (24a) with the cross-linked microfilaments (54a, b) on the first spacer block (26a).

12. Use of the textile arrangement according to claim 1 as a base for a substrate for growing a plant.
